(19) United States
(12) Patent Application Publication
(10) Pub. No.: US 2017/0061189 A1
(43) Pub. Date: Mar. 2, 2017

(54) SENSOR FOR DETECTING FINGERPRINT AND METHOD OF MANUFACTURING THE SAME

(71) Applicant: SAMSUNG ELECTRO-MECHANICS CO., LTD., Suwon-si (KR)

(72) Inventors: Yong Il KWON, Suwon-si (KR); Chang Bae LEE, Suwon-si (KR); Hyun Jun KIM, Suwon-si (KR); Young Ki LEE, Suwon-si (KR)

(73) Assignee: SAMSUNG ELECTRO-MECHANICS CO., LTD., Suwon-si (KR)

(21) Appl. No.: 15/093,997

(22) Filed: Apr. 8, 2016

(30) Foreign Application Priority Data
Sep. 1, 2015 (KR) 10-2015-0123298

(51) Int. Cl. G06K 9/00

(52) U.S. Cl. CPC G06K 9/0002; G06K 9/001

(57) ABSTRACT

Disclosed are sensors for detecting a fingerprint and methods of manufacturing the sensor. The sensor for detecting a fingerprint includes a substrate, first conductor lines formed on a surface of the substrate, an insulating layer formed on the first conductor lines, and second conductor lines formed on the insulating layer. A width of the first conductor lines or a width of the second conductor lines is 1-10 μm.

### CROSS-REFERENCE TO RELATED APPLICATION

This application claims the priority and benefit under 35 USC §119(a) of Korean Patent Application No. 10-2015-0123298, filed on Sep. 1, 2015 with the Korean Intellectual Property Office, the entire disclosure of which is incorporated herein by reference for all purposes.

### BACKGROUND

1. Field

The following description relates to a sensor for detecting a fingerprint and a method of manufacturing the sensor.

2. Description of Related Art

Sensors for detecting fingerprints detect ridges and valleys of a human fingerprint. Sensors for detecting fingerprints may be classified as ultrasound type sensors, infrared type sensors, capacitance type sensors, based on an operating principle of the sensor. Capacitance type sensors are also referred to as sensors for detecting a change of capacitance and for detecting ridges and valleys of the fingerprint.

As the need for securing mobile devices such as, for example, laptop computers, mobile phones have increased, sensors for detecting fingerprints have been applied to mobile devices. In addition, these sensors for detecting fingerprints are also used to determine whether the mobile devices are turned on/off or in a sleep mode.

To improve a fingerprint recognition rate of a capacitance type sensor for detecting a fingerprint, the resolution should be increased. In general, resolution of the sensor for detecting the fingerprint is in proportion to an area of the sensor. Since the volume and size of mobile devices are getting smaller, the sensor for detecting a fingerprint mounted in the mobile device is also required to be smaller. However, a small sensor for detecting a fingerprint may not maintain the high resolution, and the fingerprint recognition rate may deteriorate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a sensor for detecting a fingerprint, in which a line width of a conductor line of an electrode is narrowed and the conductor line is densely disposed, and a method of manufacturing the same.

In another general aspect, there is provided a sensor for detecting a fingerprint, the sensor including a substrate, first conductor lines formed on a surface of the substrate, an insulating layer formed on the first conductor lines, and second conductor lines formed on the insulating layer and crossing the first conductor lines, wherein a width of the first conductor lines or a width of the second conductor lines is 1-10 μm.

A distance between adjacent lines of the first conductor lines or a distance between adjacent lines of the second conductor lines may be 1-10 μm.

A thicknesses of the first conductor lines or a thicknesses of the second conductor lines may be 0.2-10 μm.

A thickness of the insulating layer may be 4-6 μm.

A protection layer may be formed on the second conductor lines, and a thickness of the protection layer may be 1-5 μm.

The sensor may including a wiring layer formed on another surface of the substrate, and vias formed in the substrate and the insulating layer to electrically connect the wiring layer to the first conductor lines and the second conductor lines.

The sensor may include a controller integrated circuit mounted on the wiring layer.

A hole width of the vias may be 2-10 μm and a land width of the vias may be 4-20 μm.

The wiring layer may include a ground electrode and a signal wiring electrode, the ground electrode may be configured to shield noise introduced into the sensor, and the signal wiring electrode may be configured to electrically connect the controller integrated circuit to the first conductor lines and the second conductor lines.

The controller integrated circuit may be configured to apply driving signals to the first conductor lines and to simultaneously detect the change in capacitance in the second conductor lines.

The protection layer may include solder resist (SR) and a specific inductive capacity of the protection layer may be 3.2.

In another general aspect, there is provided a method of manufacturing a sensor for detecting a fingerprint, the method including preparing a carrier, forming a wiring layer on the carrier, sequentially stacking a substrate, a first electrode, an insulating layer, and a second electrode on the wiring layer, removing the carrier, and mounting a controller integrated circuit on a surface of the wiring layer from which the carrier is removed.

The method may including forming a protection layer on the second electrode.

At least one of the first electrode, the insulating layer, the second electrode, or the protection layer may be formed by a thin film process.

The mounting of the controller integrated circuit may include mounting the controller integrated circuit in a flip-chip manner.

The method may include printing a cover lens on the protection layer.

The cover lens may be tinged by a color or pigment.

In another general aspect, there is provided a method of manufacturing a sensor for detecting a fingerprint, the method including forming a cover lens, sequentially stacking a second electrode, an insulating layer, a first electrode, and a substrate on the cover lens, forming a wiring layer on a surface of the substrate distal from the first electrode, and constructing vias in the substrate and the insulating layer to electrically connect the wiring layer to the first conductor lines and the second conductor lines.

The method may include forming an adhesion layer on the cover lens before the stacking of the second electrode.

Other features and aspects will be apparent from the following detailed description, the drawings, and the claims.

### BRIEF DESCRIPTION OF DRAWINGS

FIG. 1 is a diagram illustrating an example of an electronic device including a sensor for detecting a fingerprint.

FIG. 2 is a diagram illustrating an example of a sensor for detecting a fingerprint.

FIG. 3 is a diagram illustrating an example of a sensor for detecting a fingerprint.

FIGS. 4A through 4I are diagrams illustrating examples for describing a process of manufacturing the sensor for detecting the fingerprint of FIG. 3.

FIG. 5 is a diagram illustrating an example of a sensor for detecting a fingerprint.

FIGS. 6A through 6G are diagrams diagram illustrating an example for describing a process of manufacturing the sensor for detecting the fingerprint of FIG. 5.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the example embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular example only and is not intended to be limiting of the present examples described. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

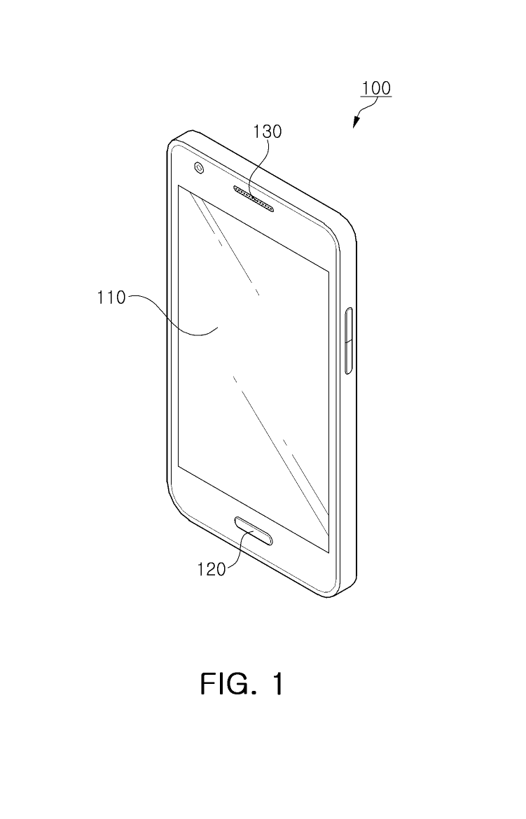

FIG. 1 is a diagram illustrating an example of an electronic device 100 including a sensor for detecting a fingerprint.

Referring to FIG. 1, the electronic device 100 includes a display apparatus 110 displaying an image, an input unit 120, and an audio unit 130 for audio output. The sensor (not shown) for detecting the fingerprint may be integrally formed with at least one of the display apparatus 110 and the input unit 120 to determine whether to release a sleep mode of the electronic device 100 and turn on/off the electronic device 100.

When the sensor for detecting the fingerprint is integrally formed with the display apparatus 110, the sensor for detecting the fingerprint needs to have a high light transmittance so that the image displayed by the display apparatus 110 may be transmitted. Thus, the sensor for detecting the fingerprint may be implemented by forming an electrode in a conductor line of a fine line width in a base substrate of a transparent film material.

The sensor for detecting the fingerprint may operate as a capacitance type sensor. The sensor may include a capacitance detecting circuit for detecting a change of capacitance generated in an electrode, an analog-digital converting circuit for converting an output signal of the capacitance detecting circuit into digital values, and an arithmetic operating circuit for determining a touch input by using data converted into the digital values.

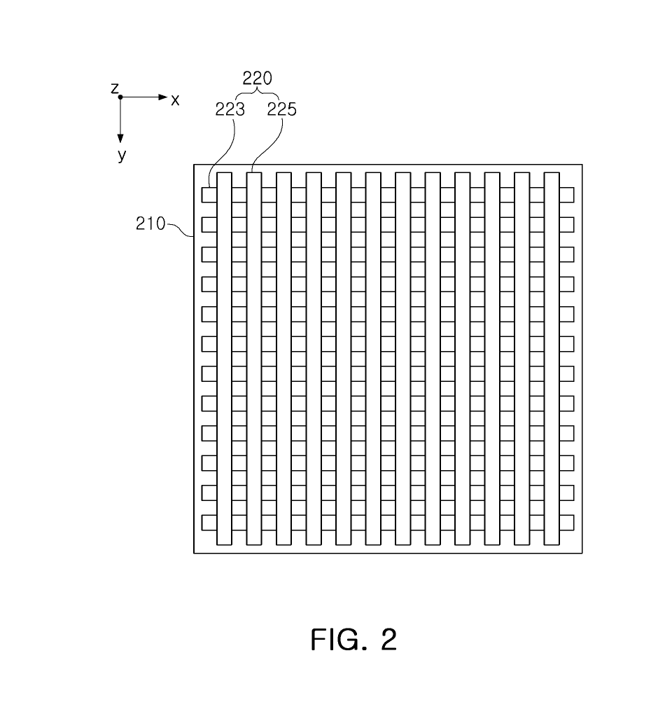

FIG. 2 is a diagram illustrating an example of a sensor for detecting a fingerprint.

Referring to FIG. 2, the sensor for detecting the fingerprint includes a substrate 210 and an electrode layer 220 formed on the substrate 210.

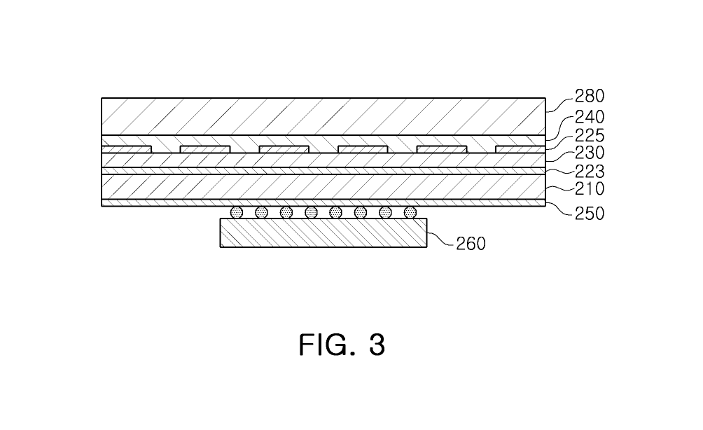

The substrate 210 may be formed of a film such as, for example, PET (polyethylene terephthalate), PC (polycarbonate), PES (polyethersulfone), PI (polyimide), PMMA (polymethylmethacrylate), or COP (cyclo-olefin polymers). In another example, the substrate 210 may be formed of a material such as, for example, soda glass or tempered glass. A plurality of first electrodes 223 and a plurality of second electrodes 225 are provided on one surface of the substrate 210 and a wiring layer (not shown, see FIG. 3) is provided on another surface of the substrate 210. A plurality of vias for electrically connecting the first electrodes 223 and the second electrodes 225 and a wiring layer (not shown, see FIG. 3) provided on another surface of the substrate 210 may be formed inside the substrate 210.

According to an embodiment, the vias of the substrate 210 may be manufactured through a thin film process. The vias may be manufactured through the thin film process in which a hole width of the vias may be 2-10 μm and a land width of the vias may be 4-20 μm.

The electrode layer 220 includes the plurality of first electrodes 223 extending in an X axis direction and the plurality of second electrodes 225 extending in a Y axis direction. The first electrodes 223 and the second electrodes 225 is formed in conductor lines. The conductor lines may be manufactured from materials, such as, for example, silver (Ag), aluminum (Al), chromium (Cr), nickel (Ni), molybdenum (Mo), copper (Cu), or alloys thereof.

According to an example, the first electrodes 223 and the second electrodes 225 may be manufactured through a thin film process. The first electrodes 223 and the second electrodes 225 may be manufactured through the thin film process in which a line width of at least one of a conductor line of each of the first electrodes 223 and the second electrodes 225 may be 1-10 μm. The distance between adjacent conductor lines of the first electrodes 223 and a distance between adjacent conductor lines of the second electrodes 225 may be 1-10 μm. At least one of thicknesses of the conductor lines of the first electrodes 223 and thicknesses of the conductor lines of second electrodes 225 may be 0.2-10 μm.

The first electrodes 223 and the second electrodes 225 may be manufactured through the thin film process, to reduce the line widths of the conductor lines of the first electrodes 223 and the second electrodes 225 and allowing the conductor lines to be disposed close to each other. The sensor for detecting the fingerprint may acquire high resolution, and a deviation of coupling capacitance generated in a plurality of cross nodes of the first electrodes 223 and the second electrodes 225 may be reduced, and thus calibration in the coupling capacitance may be easy.

Although not shown in FIG. 2, each of the first electrodes 223 and the second electrodes 225 may be electrically connected to a controller integrated circuit attached to another surface of the substrate 210. The controller integrated circuit may apply driving signals to the plurality of first electrodes 223, may detect detection signals from the plurality of second electrodes 225, and may detect the fingerprint.

The controller integrated circuit detects capacitance generated between the first electrodes 223 and the second electrodes 225 by a touch input of a user's finger and may detect a fingerprint of the finger according to a change of the detected capacitance. In an example, the controller integrated circuit operates by sequentially applying the driving signals to each of the first electrodes 223 and simultaneously detecting the change of the capacitance in the second electrodes 225.

FIG. 3 is a diagram illustrating an example of a sensor for detecting a fingerprint.

FIG. 3 is a cross-sectional view of the sensor for detecting the fingerprint taken along plane Y-Z of FIG. 2. The sensor for detecting the fingerprint includes an insulating layer 230, a protection layer 240, a wiring layer 250, a controller integrated circuit 260, substrate 210, the first electrodes 223, and the second electrodes 225, and a cover lens 280. The substrate 210, the first electrodes 223, and the second electrodes 225 are described in FIG. 2 above. The above description of FIG. 2, is also applicable to FIGS. 3, and is incorporated herein by reference. Thus, the above description may not be repeated here.

The insulating layer 230 is formed between the first electrodes 223 and the second electrodes 225 to insulate the first electrodes 223 and the second electrodes 225 from each other. When driving signals are applied to the first electrodes 223, capacitance is generated between the first electrodes 223 and the second electrodes 225 by the insulating layer 230 formed between the first electrodes 223 and the second electrodes 225. In an example, specific inductive capacity of the insulating layer 230 may be 3.2.

According to an embodiment, the insulating layer 230 may be manufactured through a thin film process. The insulating layer 230 may be manufactured through the thin film process in which a thickness of the insulating layer 230 may be 2-6 μm.

The protection layer 240 is formed on the second electrode 225, and the cover lens 280 may be formed on the protection layer 240. A user may contact the cover lens 280 with the finger(s).

The protection layer 240 may be formed to cover the second electrode 225 to protect the second electrodes 225. The protection layer 240 may be manufactured through the thin film process in which a thickness of the protection layer 240 may be 1-5 μm. In an example, the protection layer 240 may include solder resist (SR) and may have specific inductive capacity of 3.2.

In an example, the cover lens 280 is formed of a glass material, and functions as a cover window. The cover lens 280 may be formed by using glass in a printing or spraying method, and may be colored by adding paint or pigment to the glass. The colored cover lens 280 visually shields the first electrodes 223 and the second electrodes 225 that are provided on the substrate 210.

When the user's finger is in contact with the cover lens 280, the capacitance generated between the first electrodes 223 and the second electrodes 225 changes, and the fingerprint of the finger is detected according to a change in the capacitance.

The wiring layer 250 may be formed on another surface of the substrate 210, and may be manufactured by using materials, such as, for example, copper (Cu). The wiring layer 250 may include at least one of a ground electrode and a signal wiring electrode. The ground electrode shields noise introduced into the sensor for detecting the fingerprint. The signal wiring electrode is connected to the controller integrated circuit 260 to electrically connect the controller integrated circuit 260 and the first electrodes 223 and the second electrodes 225.

The controller integrated circuit 260 is mounted on the wiring layer 250. The controller integrated circuit 260 may be mounted on the wiring layer 250 in a flip-chip manner. Although not specifically shown in FIG. 3, a plurality of vias for electrically connecting the first electrodes 223 and the wiring layer 250 may be formed inside the substrate 210. The plurality of vias may extend to the second electrodes 225 through the insulating layer 230.

The controller integrated circuit 260 may be electrically connected to the first electrodes 223 and the second electrodes 225 via the signal wiring electrode of the wiring layer 250 and the plurality of vias of the substrate 210.

The sensor for detecting the fingerprint may be manufactured through the thin film process. Thus, the sensor for detecting the fingerprint may be thin, and the user's fingerprint may be detected from the thin sensor for detecting the fingerprint, thereby acquiring a high fingerprint recognition rate.

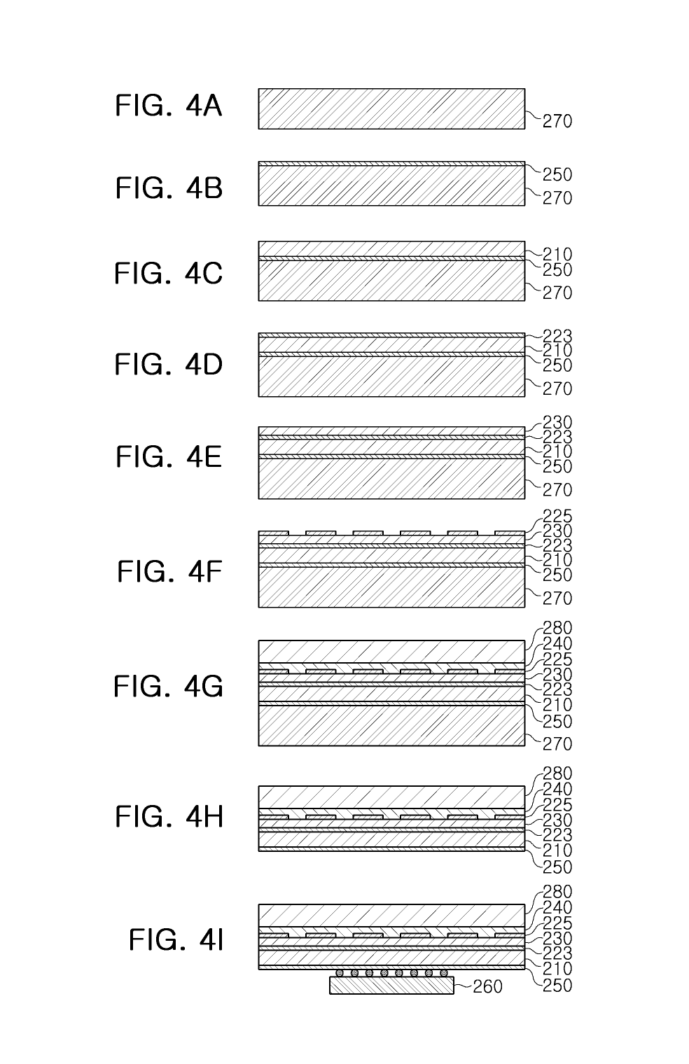

FIGS. 4A through 4I are diagrams illustrating examples for describing a process of manufacturing the sensor for detecting the fingerprint of FIG. 3. A method of manufacturing the sensor for detecting the fingerprint of FIG. 3 will now be described in detail with reference to FIGS. 4A through 4I below. The operations in FIGS. 4A through 4I may be performed in the sequence and manner as shown, although the order of some operations may be changed or some of the operations omitted without departing from the spirit and scope of the illustrative examples described. Many of the operations shown in FIGS. 4A through 4I may be performed in parallel or concurrently. The above descriptions of FIGS. 1-3 is also applicable to FIGS. 4A through 4I, and is incorporated herein by reference. Thus, the above description may not be repeated here.

Referring to FIG. 4A, a carrier 270 is prepared. In FIG. 4B, the wiring layer 250 is formed on the carrier 270. According to an embodiment, the carrier 270 may be manufactured of glass to increase conveyance convenience of a layer or a film that is stacked on the carrier 270.

In an example, the wiring layer 250 may be formed of copper (Cu). The wiring layer 250 may include a ground electrode for shielding against noise introduced into the sensor for detecting the fingerprint and a signal wiring electrode connected to the controller integrated circuit 260.

Referring to FIG. 4C, the substrate 210 having a relatively heavy weight may be stacked on the wiring layer 250, to improve adhesion of the wiring layer 250 and the substrate 210.

In an example, the substrate 210 may be formed of a film such as, for example, PET (polyethylene terephthalate), PC (polycarbonate), PES (polyethersulfone), PI (polyimide), PMMA (polymethylmethacrylate), COP (cyclo-olef in polymers), or a material such as soda glass or tempered glass.

In an example, a plurality of vias for electrically connecting the first electrodes 223 and the second electrodes 225 to the wiring layer 250 is formed inside the substrate 210. The first electrodes 223 and the second electrodes 225 are provided on one surface of the substrate 210, and the wiring layer 250 is provided on another surface of the substrate 210.

Referring to FIGS. 4D through 4F, the first electrodes 223, the insulating layer 230, and the second electrodes 225 are sequentially stacked and formed on the substrate 210. The first electrodes 223 and the second electrodes 225 may be formed in conductor lines. The conductor lines may be manufactured as described above.

The insulating layer 230 is formed between the first electrodes 223 and the second electrodes 225 to insulate the first electrodes 223 and the second electrodes 225 from each other. When driving signals are applied to the first electrodes 223, capacitance is generated between the first electrodes 223 and the second electrodes 225 by the insulating layer 230 formed between the first electrodes 223 and the second electrodes 225.

Referring to FIGS. 4G, the protection layer 240 and the cover lens 280 may be sequentially formed on the second electrode 225.

The protection layer 240 is formed on the second electrode 225, and the cover lens 280 may be formed on the protection layer 240, and a finger of a user may contact the cover lens 280.

The protection layer 240 is formed to cover the second electrode 225 and to protect the second electrodes 225. The protection layer 240 may be manufactured through the thin film process in which a thickness of the protection layer 240 may be 1-5 μm. In an example, the protection layer 240 may include solder resist (SR) and may have specific inductive capacity of 3.2.

The cover lens 280 may be formed of a glass material, and may function as a cover window. The cover lens 280 may be formed using glass in a printing or spraying method, and may be colored by adding paint or pigment to the glass. The colored cover lens 280 visually shields the first electrodes 223 and the second electrodes 225 that are provided on the substrate 210. When the user's finger is in contact with the cover lens 280, the capacitance generated between the first electrodes 223 and the second electrodes 225 changes, and the fingerprint of the finger is detected according to a change in the capacitance.

Referring to FIGS. 4H, after the protection layer 240 and the cover lens 280 are formed on the second electrode 225, the carrier 270 is removed. Referring to FIGS. 4I, the controller integrated circuit 260 is mounted on the wiring layer 250. The controller integrated circuit 260 may be mounted on the wiring layer 250 in a flip-chip manner. The controller integrated circuit 260 is electrically connected to the first electrodes 223 and the second electrodes 225 via the signal wiring electrode of the wiring layer 250 and the plurality of vias of the substrate 210. Although not specifically shown, a ground electrode layer for shielding against noise formed between the wiring layer 250 and the first electrodes 223 may be formed on the substrate 210.

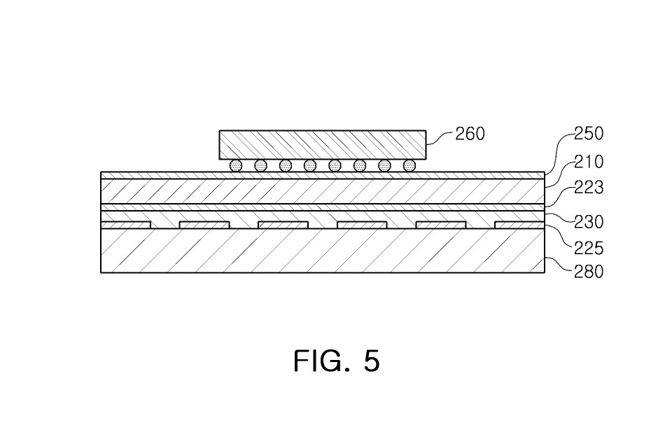

FIG. 5 is a diagram illustrating an example a sensor for detecting a fingerprint. FIG. 5 is a cross-sectional view of the sensor for detecting the fingerprint taken along plane Y-Z of FIG. 2. The sensor for detecting the fingerprint includes the insulating layer 230, the wiring layer 250, and the controller integrated circuit 260, the substrate 210, the first electrodes 223, and the cover lens 280. Some of these components are described in FIGS. 1-4I above. The above description of FIGS. 1-4I, is also applicable to FIGS. 5, and is incorporated herein by reference. Thus, the above description may not be repeated here.

The example of the sensor for detecting the fingerprint of FIG. 5 is similar to the example of the sensor for detecting the fingerprint shown in FIG. 3. Thus, redundant descriptions are omitted, and differences will be described.

Referring to the sensor for detecting the fingerprint of FIG. 5, the second electrode 225 of FIG. 5 may directly adhered to the cover lens 280. While the second electrode 225 of the sensor for detecting the fingerprint of FIG. 3 is adhered to the cover lens 280 via the protection layer 240. The protection layer 240 may be removed to reduce manufacturing cost and improve processing yield.

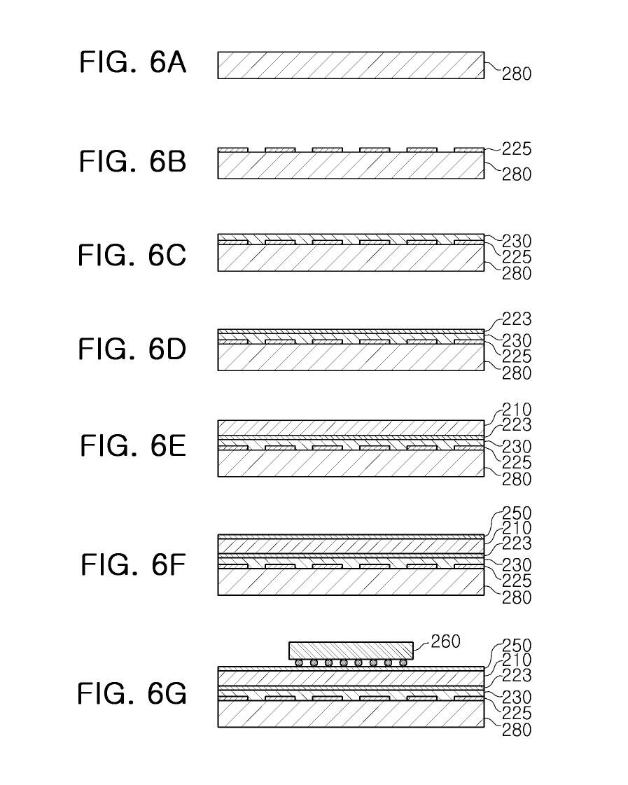

FIGS. 6A through 6G are diagrams illustrating example of a process of manufacturing the sensor for detecting the fingerprint of FIG. 5. A method of manufacturing the sensor for detecting the fingerprint of FIG. 5 will be described in detail with reference to FIGS. 6A through 6G below. The operations in FIGS. 6A through 6G may be performed in the sequence and manner as shown, although the order of some operations may be changed or some of the operations omitted without departing from the spirit and scope of the illustrative examples described. Many of the operations shown in FIGS. 6A through 6G may be performed in parallel or concurrently. The above descriptions of FIGS. 1-5 is also applicable to FIGS. 6A through 6G, and is incorporated herein by reference. Thus, the above description may not be repeated here.

Referring to FIG. 6A, the cover lens 280 may be prepared.

The cover lens 280 may be formed of a glass material, and may function as a cover window. The cover lens 280 may be formed using glass in a printing or spraying method, and may be colored by adding paint or pigment to the glass. The colored cover lens 280 visually shields the first electrodes 223 and the second electrodes 225 that are provided on the substrate 210.

According to an embodiment, the cover lens 280 may be used as a carrier, thereby reducing manufacturing cost and simplifying a manufacturing process, compared to the manufacturing method of FIG. 4.

Referring to FIG. 6B, the second electrodes 225 is formed on the cover lens 280. Although not shown, a titanium (Ti) layer may be additionally formed between the cover lens 280 and the second electrode 225. The titanium (Ti) layer may function as an adhesion layer of the cover lens 280 and the second electrode 225.

Referring to FIG. 6C, the insulating layer 230 may be formed to cover the second electrode 225. Referring to FIG. 6D, the first electrode 223 may be formed on the insulating layer 230. The first electrodes 223 and the second electrodes 225 may be formed in conductor lines. The conductor lines may be manufactured as described above.

The insulating layer 230 is formed between the first electrodes 223 and the second electrodes 225 to insulate the first electrodes 223 and the second electrodes 225 from each other. In a case in which driving signals are applied to the first electrodes 223, capacitance is generated between the first electrodes 223 and the second electrodes 225 by the insulating layer 230 formed between the first electrodes 223 and the second electrodes 225.

Referring to FIG. 6E, the substrate 210 may be formed on the first electrodes 223. The substrate 210 may be formed of a film such as, for example, PET (polyethylene terephthalate), PC (polycarbonate), PES (polyethersulfone), PI (polyimide), PMMA (polymethylmethacrylate), COP (cyclo-olef in polymers), or a material such as soda glass or tempered glass.

The first electrodes 223 and the second electrodes 225 are provided on one surface of the substrate and the wiring layer 250 is provided on another surface of the substrate 210. A plurality of vias for electrically connecting the first electrodes 223 and the second electrodes 225 and the wiring layer 250 are formed inside the substrate 210.

Referring to FIG. 6F, the wiring layer 250 is formed on the substrate 210. Referring to FIG. 6G, the controller integrated circuit 260 may be mounted on the wiring layer 250. In an example, the wiring layer 250 is formed of copper (Cu). The wiring layer 250 includes a ground electrode for shielding against noise introduced into the sensor for detecting the fingerprint and a signal wiring electrode connected to the controller integrated circuit 260. The controller integrated circuit 260 is electrically connected to the first electrodes 223 and the second electrodes 225 via the signal wiring electrode of the wiring layer 250 and the plurality of vias of the substrate 210. Although not specifically shown, a ground electrode layer for shielding against noise formed between the wiring layer 250 and the first electrodes 223 are additionally formed in the substrate 210.

As set forth above, a sensor for detecting a fingerprint may acquire a high resolution and fingerprint recognition rate.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A sensor for detecting a fingerprint, the sensor comprising:
first conductor lines formed on the surface of the substrate;
an insulating layer formed on the first conductor lines; and
second conductor lines formed on the insulating layer, and crossing the first conductor lines,
wherein a width of the first conductor lines or a width of the second conductor lines is 1 to 10 μm.

2. The sensor of claim 1, wherein a distance between adjacent lines of the first conductor lines or a distance between adjacent lines of the second conductor lines is 1 to 10 μm.

3. The sensor of claim 1, wherein a thicknesses of the first conductor lines or a thicknesses of the second conductor lines is 0.2 to 10 μm.

4. The sensor of claim 1, wherein a thickness of the insulating layer is 4 to 6 μm.

5. The sensor of claim 1, further comprising a protection layer formed on the second conductor lines, and a thickness of the protection layer is 1 to 5 μm.

6. The sensor of claim 1, further comprising:
a wiring layer formed on another surface of the substrate; and
vias formed in the substrate and the insulating layer to connect the wiring layer to the first conductor lines and the second conductor lines.

7. The sensor of claim 6, further comprising a controller integrated circuit mounted on the wiring layer.

8. The sensor of claim 6, wherein a hole width of the vias are 2 to 10 μm and a land width of the vias are 4 to 20 μm.

9. The sensor of claim 7, wherein the wiring layer comprises a ground electrode and a signal wiring electrode, the ground electrode being configured to shield noise introduced into the sensor, and the signal wiring electrode being configured to electrically connect the controller integrated circuit to the first conductor lines and the second conductor lines.

10. The sensor of claim 7, wherein the controller integrated circuit is configured to apply driving signals to the first conductor lines and to simultaneously detect the change in capacitance in the second conductor lines.

11. The sensor of claim 1, wherein the protection layer comprises solder resist (SR) and a specific inductive capacity of the protection layer is 3.2.

12. A method of manufacturing a sensor to detect a fingerprint, the method comprising:
preparing a carrier;
forming a wiring layer on the carrier;
sequentially stacking a substrate, a first electrode, an insulating layer, and a second electrode on the wiring layer;
removing the carrier; and
mounting a controller integrated circuit on a surface of the wiring layer from which the carrier is removed.

13. The method of claim 11, further comprising forming a protection layer on the second electrode.

14. The method of claim 12, wherein at least one of the first electrode, the insulating layer, the second electrode, or the protection layer is formed by a thin film process.

15. The method of claim 11, wherein the mounting of the controller integrated circuit comprises mounting the controller integrated circuit in a flip-chip manner.

16. The method of claim 11, further comprising printing a cover lens on the protection layer.

17. The method of claim 11, wherein the cover lens is tinged by a color or pigment.

18. A method of manufacturing a sensor to detect a fingerprint, the method comprising:
forming a cover lens;
sequentially stacking a second electrode, an insulating layer, a first electrode, and a substrate on the cover lens;
forming a wiring layer on a surface of the substrate distal from the first electrode; and
constructing vias in the substrate and the insulating layer to electrically connect the wiring layer to the first conductor lines and the second conductor lines.

19. The method of claim 18, further comprising forming an adhesion layer on the cover lens before the stacking of the second electrode.
